(19) United States
(12) Patent Application Publication
(10) Pub. No.: US 2016/0011757 A1
(43) Pub. Date: Jan. 14, 2016

(54) EMAIL AND TASK MANAGEMENT PLATFORM

(71) Applicant: Atrendia ApS, Kokkedal (DK)

(72) Inventor: Michael Hoffman, Barcelona (ES)

(21) Appl. No.: 14/794,541

(22) Filed: Jul. 8, 2015

Related U.S. Application Data
(60) Provisional application No. 62/022,240, filed on Jul. 9, 2014.

(51) Int. Cl. G06F 3/0484; G06F 3/0488

(52) U.S. Cl. CPC G06F 3/04847; G06F 3/0488; G06F 3/04842

(57) ABSTRACT

An email and task management platform may be provided. Embodiments of the present disclosure may receive an email to be associated with task items. The emails may be displayed in, for example, a list view. The display may be functional on a touch-screen device, enabling the user to select a priority for the email based on a swipe motion received from the user. Once prioritized, the platform may enable the user to provide planning details for the email, such as, for example, a next action, an assignee, and a due date to be associated with the email. In this way, the platform may create a prioritized and planned task. The tasks may then be displayed as a prioritized tasks list comprised of prioritized and planned emails in an inbox view. The prioritization and planning of emails may provide a streamlined, intuitive, and effective interface for organizing emails in an inbox.

### RELATED APPLICATION

Under provisions of 35 U.S.C. §119(e), the Applicants claim the benefit of U.S. provisional application No. 62/022,240, filed Jul. 9, 2014, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to email and task management.

### BACKGROUND

Individuals often have to schedule and prioritize tasks. The tasks may involve, for example, responding to communications of varying levels of importance. The responsibilities of such task completion are often created or delegated through email. The conventional strategy for organizing email related tasks involves sifting through emails and manually creating an organized plan for responding to emails and fulfilling required tasks. However, this can cause problems if tasks are missed or improperly organized, particularly in a busy, dynamic working environment.

### BRIEF OVERVIEW

An email and task management platform may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

An email and task management platform may be provided. Embodiments of the present disclosure may receive an email to be associated with task items. The emails may be displayed in, for example, a list view. The display may be functional on a touch-screen device, enabling the user to select a priority for the email based on a swipe motion received from the user. Once prioritized, the platform may enable the user to provide planning details for the email, such as, for example, a next action, an assignee, and a due date to be associated with the email. In this way, the platform may create a prioritized and planned task. The tasks may then be displayed as a prioritized tasks list comprised of prioritized and planned emails in an inbox view. The prioritization and planning of emails may be performed prior to revealing the contents of the emails, thereby providing a streamlined, intuitive, and effective interface for organizing emails in an inbox.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing an email and task management platform;

FIG. 3 is a screenshot consistent with embodiments of the present disclosure demonstrating a prioritization stage, wherein mails have yet to be prioritized;

FIG. 4 is a first screenshot demonstrating a swish (or ‘swipe’) function of a mobile device implementation of the prioritization stage;

FIG. 5 is a second screenshot demonstrating the swish function of the mobile device implementation of the prioritization and archiving stage;

FIG. 6 is a third screenshot demonstrating a progression of the swish function of the mobile device implementation of the prioritization stage;

FIG. 7 is a fourth screenshot demonstrating the swish function of the mobile device implementation of the prioritization stage in which a mail is being archived;

FIG. 8 is fifth screenshot demonstrating the swish function of the mobile device implementation of the prioritization stage in which a mail is being archived;

FIG. 9 is a sixth screenshot demonstrating the swish function of the mobile device implementation of the prioritization stage in which a mail is being deleted;

FIG. 10 is a screenshot consistent with embodiments of the present disclosure demonstrating a planning stage where mails have been planned;

FIG. 11 is a screenshot consistent with embodiments of the present disclosure showing a mail that has yet to be prioritized and planned, with both actions enabled to be performed by tapping on the mail and opening it to get to that functionality;

FIG. 12 is a screenshot consistent with embodiments of the present disclosure showing a mobile device implementation of the planning stage with the priority, next action and due date completed;

FIG. 13 is a screenshot consistent with embodiments of the present disclosure showing a mobile device implementation of the planning stage with only the priority selected;

FIG. 14 is a screenshot showing the implementation of the planning stage without the priority discussed;

FIG. 15 is a screenshot showing the mobile device implementation of the planning stage with only the priority discussed;

FIG. 16 is a screenshot consistent with embodiments of the present disclosure showing a mobile device implementation of an empty Today view;

FIG. 17 is a screenshot consistent with embodiments of the present disclosure demonstrating a “Today” view (Today being Sep. 8, 2009);

FIG. 18 is a screenshot showing a mobile device implementation of the Today view;

FIG. 19 is a screenshot showing a first mobile device implementation of an All view;

FIG. 20 is a screenshot showing a second mobile device implementation of the All view;

FIG. 21 is a screenshot consistent with embodiments of this present disclosure for tasks sorted by category, then date;

FIG. 22 is a screenshot consistent with embodiments of the present disclosure demonstrating a first function;

FIG. 23 is a screenshot consistent with embodiments of the present disclosure demonstrating a second function;

FIG. 24 is a screenshot consistent with embodiments of the present disclosure demonstrating the Print-screen function;

FIG. 25 illustrates a screenshot of a Today view as a Microsoft Outlook® plug-in;

FIG. 26 illustrates a screenshot of an All view as a Microsoft Office plug-in;

FIG. 27 illustrates a screenshot showing buttons for using features “Send with Category” and “Add me to BCC”, respectively;

FIG. 28 illustrates a screenshot for a support page within the Microsoft Outlook® program;

FIG. 29 illustrates an “other options” menu consistent with embodiments of the present disclosure;

FIG. 30 illustrates screenshots for choosing or creating a new category of task and/or email;

FIG. 31 illustrates a screenshot of the All view

FIG. 32 illustrates a screenshot for a Shared Inbox Challenge;

FIG. 33 illustrates a screenshot for a Shared Inbox Solution;

FIG. 34 illustrates a shared inbox set-up menu consistent with embodiments of the present disclosure;

FIG. 35 illustrates a shared inbox toolbar;

FIG. 36 illustrates sorting options for a shared inbox;

FIG. 37 illustrates scenarios for the shared inbox;

FIG. 38 illustrates further scenarios for the shared inbox; and

FIG. 39 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. As should be understood, any embodiment may incorporate only one or a plurality of the above-disclosed aspects of the display and may further incorporate only one or a plurality of the above-disclosed features. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of email prioritization, embodiments of the present disclosure are not limited to use only in this context. For example, tasks from various calendar programs and applications may be prioritized and organized as well.

I. Platform Overview

Consistent with embodiments of the present disclosure, an email task management platform may be provided. This overview is provided to introduce a selection of concepts in a simplified form that are further described below. This overview is not intended to identify key features or essential features of the claimed subject matter. Nor is this overview intended to be used to limit the claimed subject matter's scope. The platform may be used by individuals and/or companies to process and organize emails and tasks. The platform may facilitate the management of emails and tasks by enabling users to prioritize, plan, categorize and execute tasks as an added function to electronic mail objects. As will be described below, certain embodiments of the present disclosure may utilize the functionality of a touch-screen on, for example, a mobile computing device.

Embodiments of the present disclosure provide methods and systems for sorting and organizing email objects, modifying email objects, and creating an organized task list based on email objects. The various methods and systems may be embodied in, for example, the email and task management platform of the present disclosure. The platform may be accessible via desktop or mobile computing devices, and, in certain embodiments, reside in a cloud-computing environment.

First, the platform may enable a user to prioritize received email. For instance, when the user receives an email, the platform may provide the user with an interface through which the user may delete, archive or assign an email object with a priority level. Then, the platform may enable the user to associate the email with an action to be taken. For example, the platform may enable the user to specify a task description along with a due date that is to be taken in view of the email. Once the emails have been organized and assigned an action, the platform may sort the emails in various organized views. A view may be created by defining the fields and filtering objects in a folder based on the defined fields.

In each view, the emails may be displayed in a list view that is sorted by priority. The list view may display a plurality of fields associated with the email, comprising, but not limited to, the following fields: sender, recipient, subject line, date of communication, priority level, assigned action, assigned party, and assigned due date. The platform may provide the organized views as, for example, a “Today” view that displays the emails that were assigned a due date even with or occurring before a current date or, for example, an “All” view that displays all emails.

Consistent with embodiments of the present disclosure, the user interface of the platform may be customized to the device accessing the platform. For example, a desktop computing device may be provided with one set of user interface features and functions, while a mobile computing device may be provided with another set of user interface features and functions.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Platform Configuration

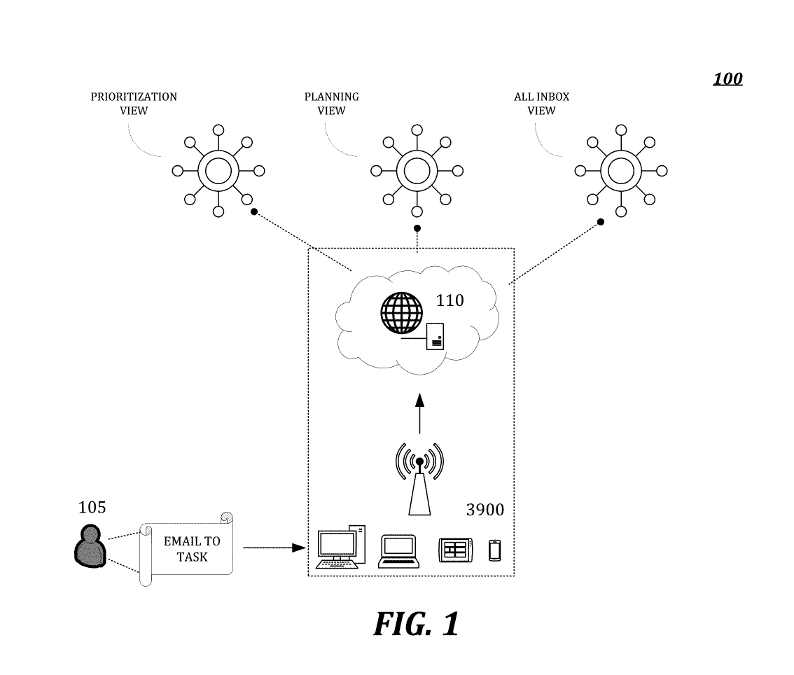

FIG. 1 illustrates one possible operating environment through which a platform consistent with embodiments of the present disclosure may be provided. By way of non-limiting example, an email and task management platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device 3900. One possible embodiment of the software application may be provided by the LeanMail™ suite of products and services provided by Atrendia.

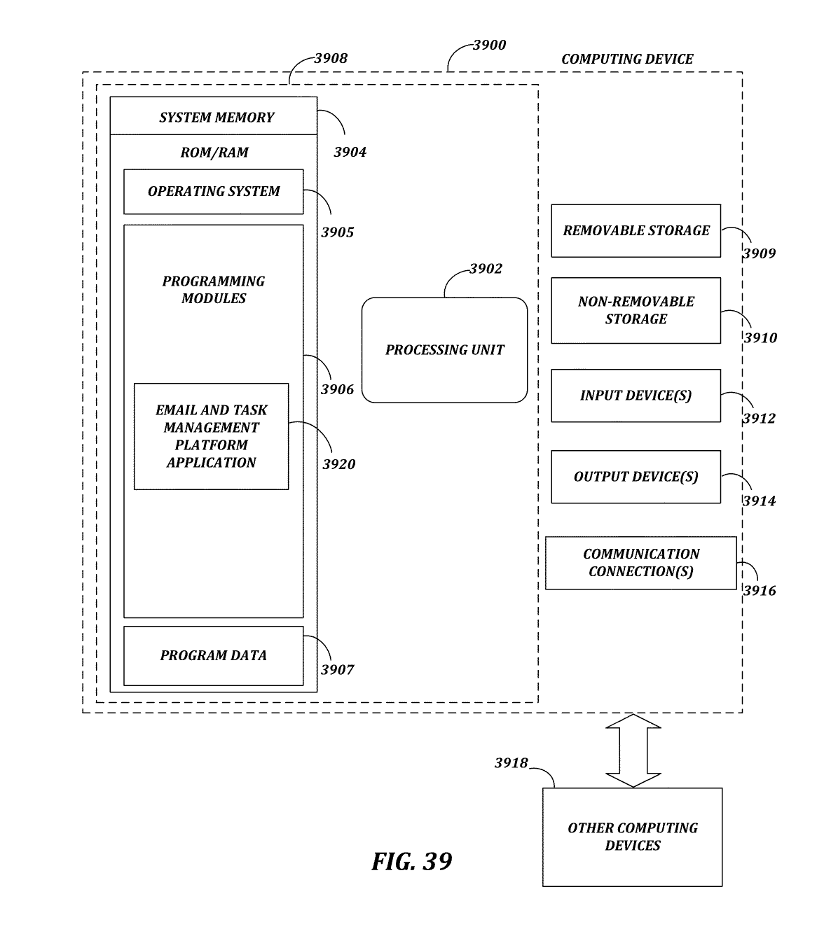

As will be detailed with reference to FIG. 39 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein. Moreover, actions taken on the mobile telecommunications device may be synchronized with the client-side application, which, in some instances, may enable the user to perform more detailed operations.

Embodiments of this present may be configured as an add-in or plug-in to stand-alone software such as, for example, but not limited to, Microsoft Outlook. The platform may synchronize with email servers through, for example, MS Exchange, POP or IMAP protocols, and the like. In other embodiments, the platform may comprise a proprietary email management software provided along with the platform itself. Further, embodiments of the platform may be configured as an add-in or plug-in to web-based apps and software, such as, for example, Google's Gmail, Yahoo's Ymail, Microsoft's Hotmail, and the like.

In addition, embodiments of the platform may be enabled as a stand-alone mobile device software, such as, for example, a smartphone app. The stand-alone software may synchronize with Microsoft Exchange Servers, or other POP and IMAP enabled email services via an intermediary server. As certain adaptations to these existing email services and protocols may be required, the platform may comprise a middleware server residing in, for example, a cloud-computing environment, in order to process, adapt, and configure email fields and objects. For example, Windows Communication Foundation (WCF) service may be created to use the Microsoft Exchange Web Service managed API and act as a middle tier between embodiments of this present disclosure and Microsoft Exchange.

III. Platform Operation

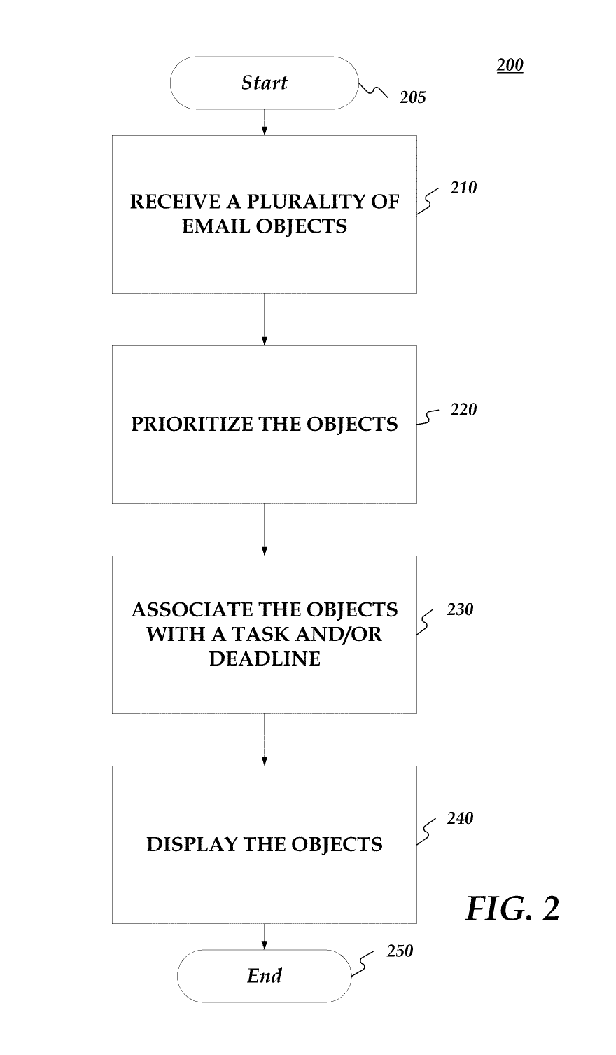

FIG. 2 is a flow chart setting forth the general stages involved in a method 200 consistent with an embodiment of the disclosure for providing an email and task management platform 100. Method 200 may be implemented using a computing device 3900 as described in more detail below with respect to FIG. 39.

Although method 200 has been described to be performed by computing device 3900, it should be understood that, in some embodiments, different operations may be performed by different networked elements in operative communication with computing device 3900. For example, server 110 and/or computing device 3900 may be employed in the performance of some or all of the stages in method 200. Moreover, server 110 may be configured much like computing device 3900 and, in some instances, be one and the same embodiment.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

Method 200 may begin at starting block 205 and proceed to stage 210 where computing device 3900 may provide a user with a graphical user interface (GUI) to enable the various features and functions of the platform. These functions may be presented in logical groupings displayed with, for example, an email management software (which, in some embodiments, may be incorporate within the platform itself). The logical groupings may be present as a GUI element within the software such as, for example, a toolbar.

The GUI may contain, for example, selectable elements which, when selected, are operative to cause the platform to provide a functionality. For example, the GUI may comprise selectable elements that enable a user to switch between different email views, as will be discussed with reference to stage 240. Moreover, the GUI may comprise selectable elements that enable the user to change from the prioritization stage to a planning stage of the platform, as will be discussed with reference to stages 220 and 230, respectively. Moreover, and as further detail below, the GUI may further comprise additional selectable elements which may provide a specific functionality as it relates to a selected email object or objects.

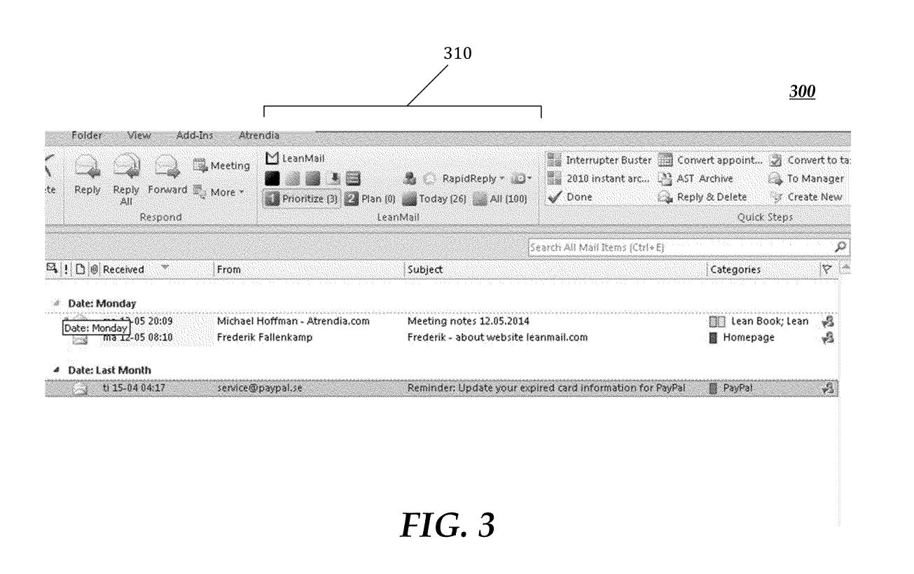

From stage 210, where computing device 3900 provides a GUI, method 200 may proceed to stage 220 where computing device 200 may receive a user selection of a first selectable element. In response to the selection, the platform may enter a prioritization stage. During the prioritization stage, computing device 3900 may display a user's unopened or opened emails in the “Prioritize” view. FIG. 3 shows a screenshot of the prioritize view 300 displayed as an add-in in Microsoft Outlook®. An embodiment of toolbar 310 is shown.

From the prioritize view, the user may view new messages that have not been prioritized or archived. The prioritize view may enable the user to select the priority of the message as, for example, “High” or “Normal”. The user may do so, for example, by selecting the corresponding button in the overhead menu. Further, the user may archive, respond to, categorize or delete messages in this prioritize view or in any other view.

Stage 220 may be performed using embodiments of the present disclosure in mobile application and/or touch screen interface. In these embodiments, computing device 3900 may comprise a mobile computing device such as, for example, a tablet or smartphone. In addition to displaying messages, the mobile app may allow the user to perform the capabilities described above in the prioritize view using a swish (or swipe) gesture. The following swish descriptions are not meant to limit the scope of embodiments of the present disclosure. Rather, they are meant to demonstrate how different types of swiping may triggering the operation of different functions within the platform.

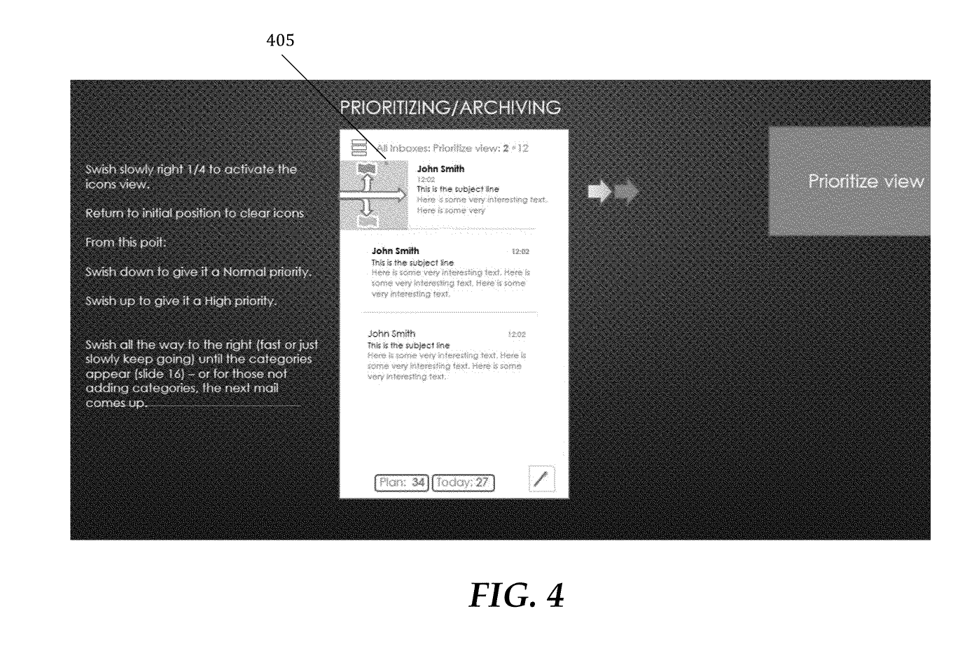

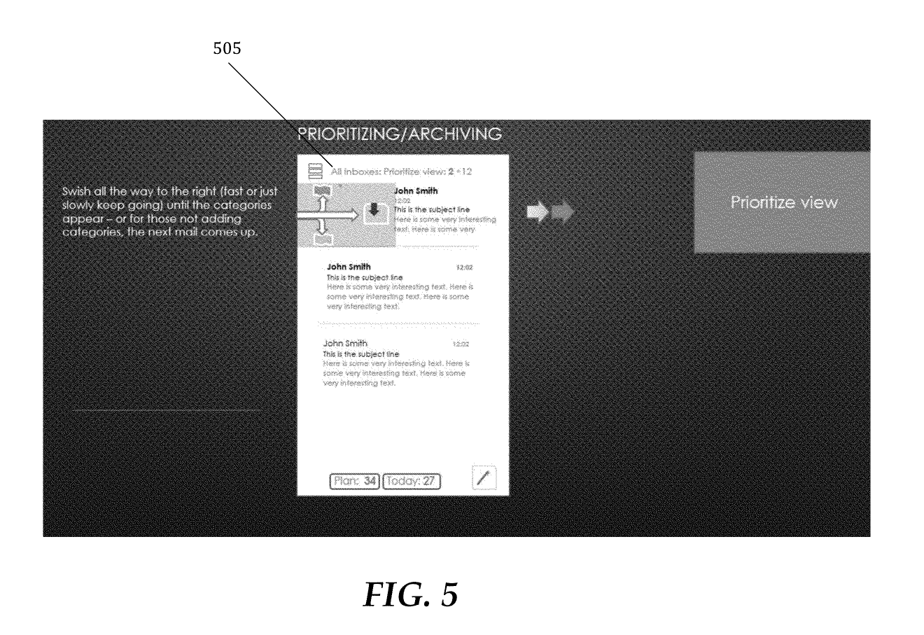

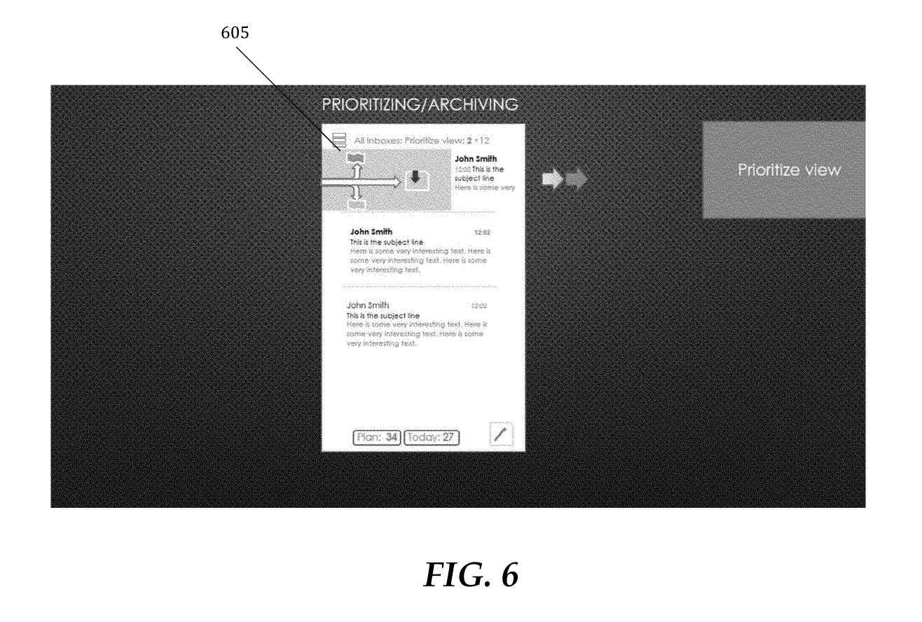

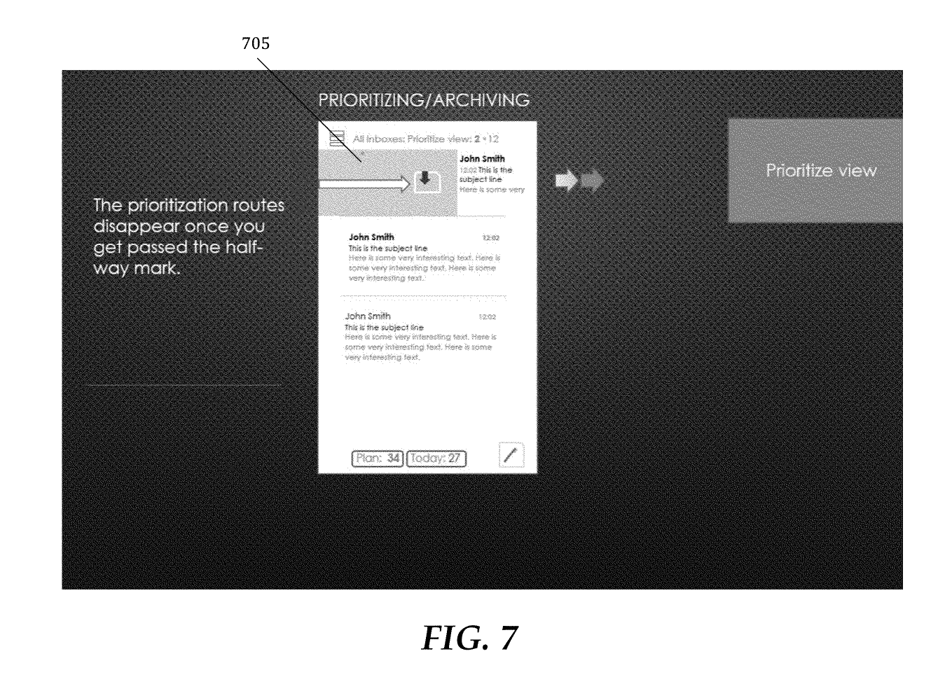

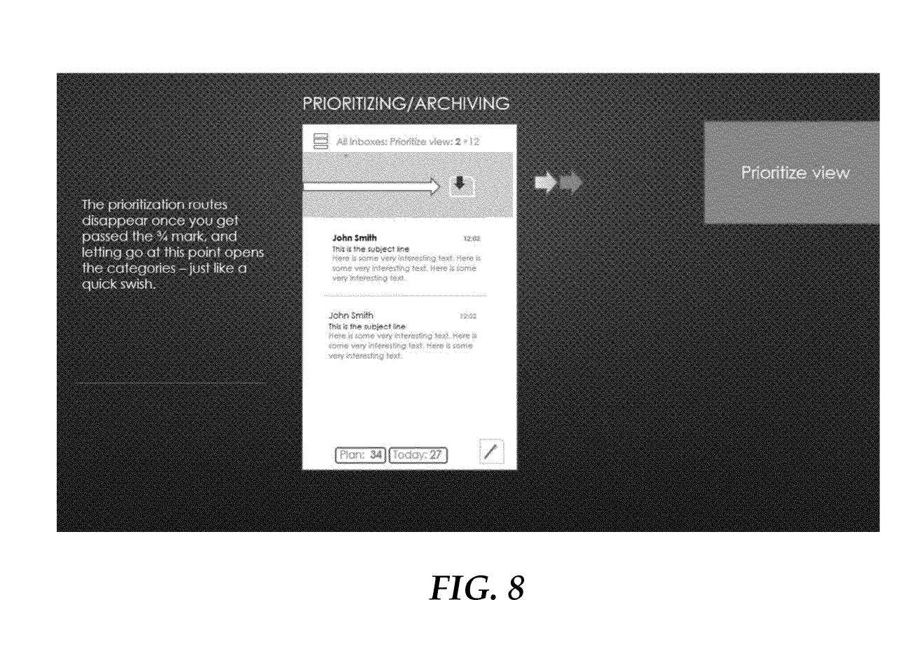

As an example, if the touch screen registers a swish to the right of the screen by, for example, approximately ¼ of the way across the screen, the app may give the user the option to swish up for high priority, down for low priority, all of the way right to archive or back to the left to cancel. FIGS. 4-6 show a response on mobile apps consistent with embodiments of the present disclosure for this swish function at ¼ across the screen from left to right 405, this swish function at, for example, approximately half-way across the screen 505, and this swish function at between ½ and ¾ of the way across the screen 605, respectively. A fast right-swish may archive the message or open up the potential archive category menu, allowing the user to select a category before archiving the mail. FIGS. 7-8 illustrate a swish gesture for archiving messages, and a response on mobile apps consistent with embodiments of the present disclosure for a swish function as the app begins archiving 705 and completes archiving 805.

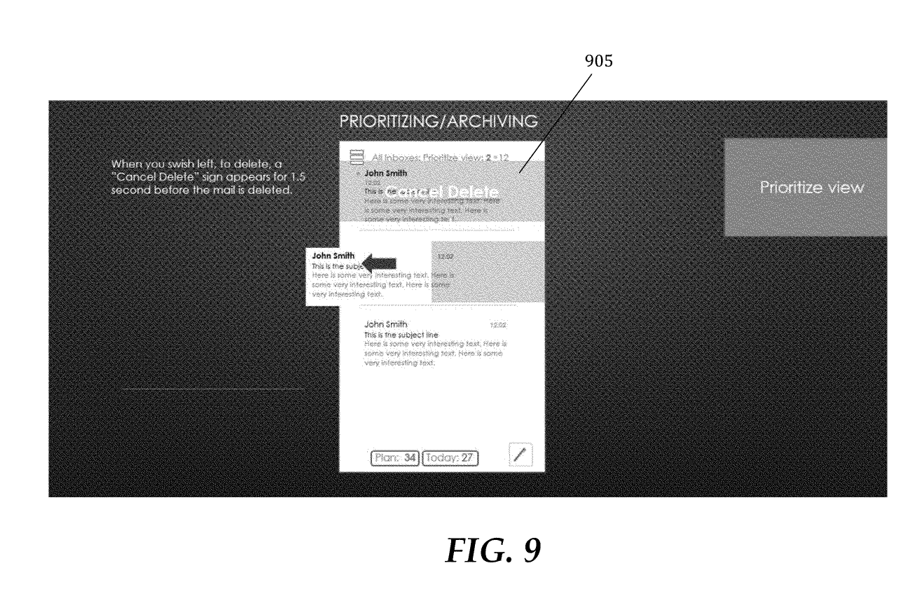

A swish to the left may delete the message after giving the user a number of seconds to cancel the delete by pressing a cancellation button 905. FIG. 9 illustrates a swish gesture for deleting. After prioritizing, achieving, or deleting, the message may disappear from the prioritize view. In this way, once the user has, via the platform, processed all of the unread emails in the prioritization stage, there may be no emails left to display in the prioritize view.

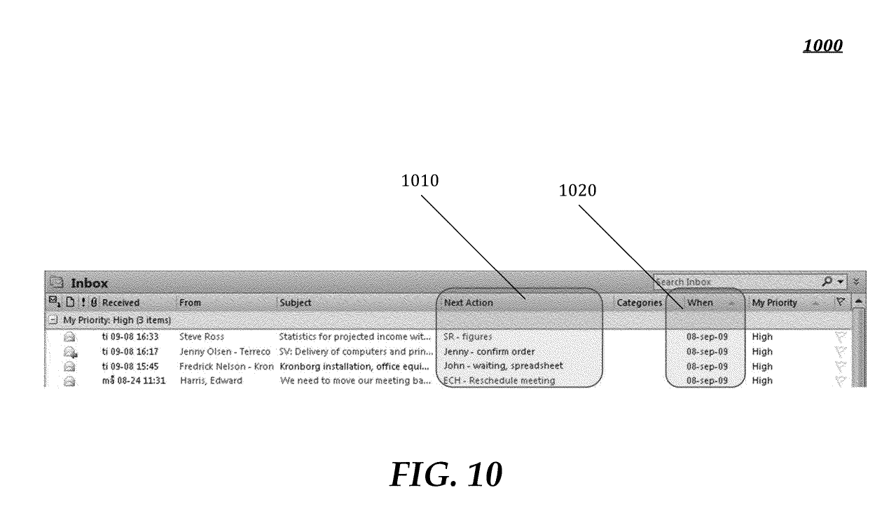

From stage 220, where the messages are prioritized, method 200 may automatically proceed to stage 230 where computing device 3900 may enable the user to see the previously prioritized emails in the “Plan” view. FIG. 10 shows a shows a screenshot 1000 of the plan view displayed as an add-in in Microsoft Outlook®. Embodiments of the platform may enable the user to add a “next action” 1010 that may be entered into two separate fields (Who and When 1020), which are then combined when seen in the various views, that allows the user to attach a description of the next step to take with the email object.

It should be noted that the user may input data into the field associated with each mail object, rather than the mail object itself. Such fields may be displayed in a Plan, Today or All view, without regard or concurrent display of the contents of the mail object itself. In this way, a user of the platform may be enabled to tabulate a plurality of fields for a plurality of mail objects before and/or without examining the contents of mail object itself. Such implementation may enable an ease of navigation for the planning phase of embodiments disclosed herein. Moreover, the platform may enable the user to assign a due date to the email object. In this way, an email object may be presented as a task object associated with the email object.

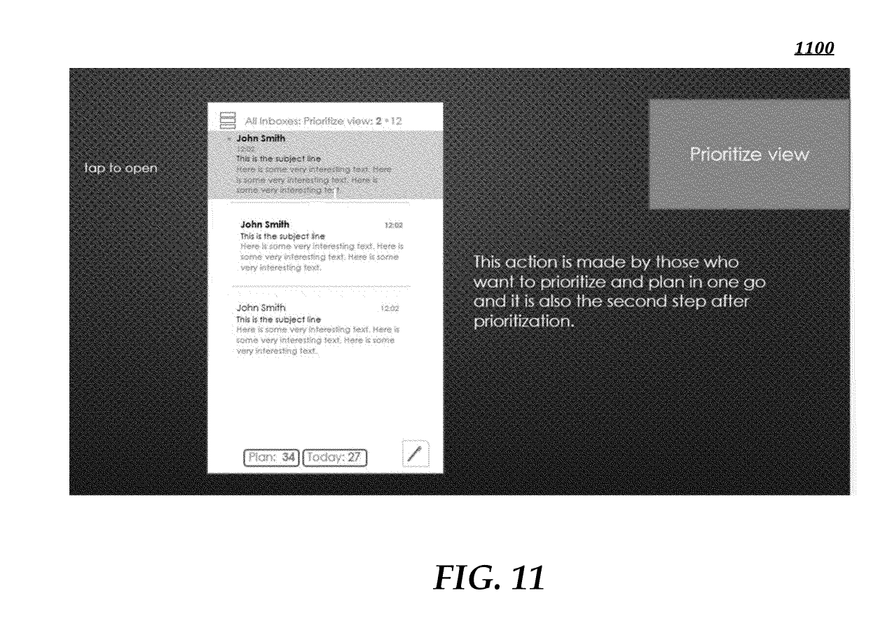

Accordingly, by enabling the user to prioritize and plan email objects in, for example, a listing view of the mail objects without requiring the user to open the mail object, the platform may provide an intuitive, structured, and organized flow to setting mail objects as prioritized and planned task items. These prioritized and planned items may then be presented to the user in a way that both reflects the mail object and the tasks associated with the mail object itself in an ‘inbox’ view. As seen in FIG. 10, additional fields may be added to the email object to enable such presentation. FIG. 11 is a screenshot consistent with embodiments of the present disclosure showing the planning stage with the priority 1100, next action and due date completed.

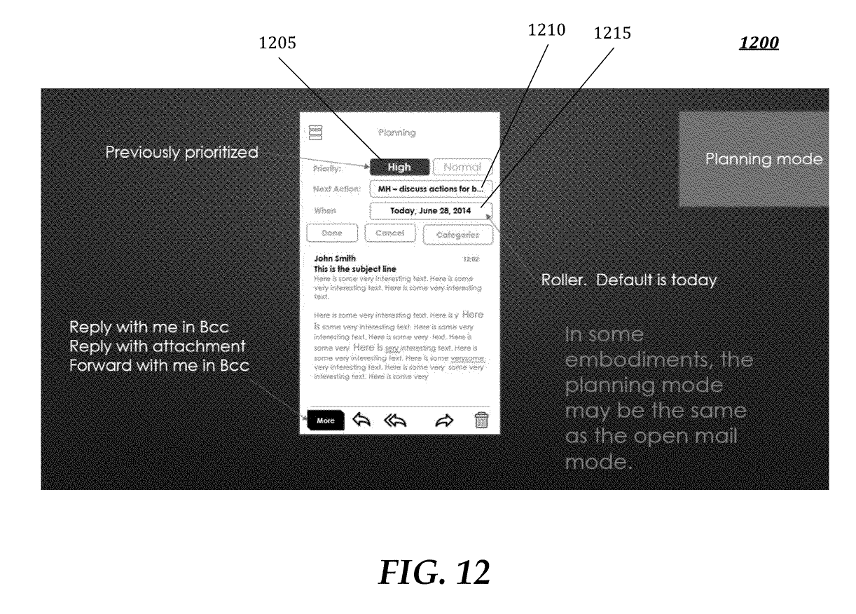

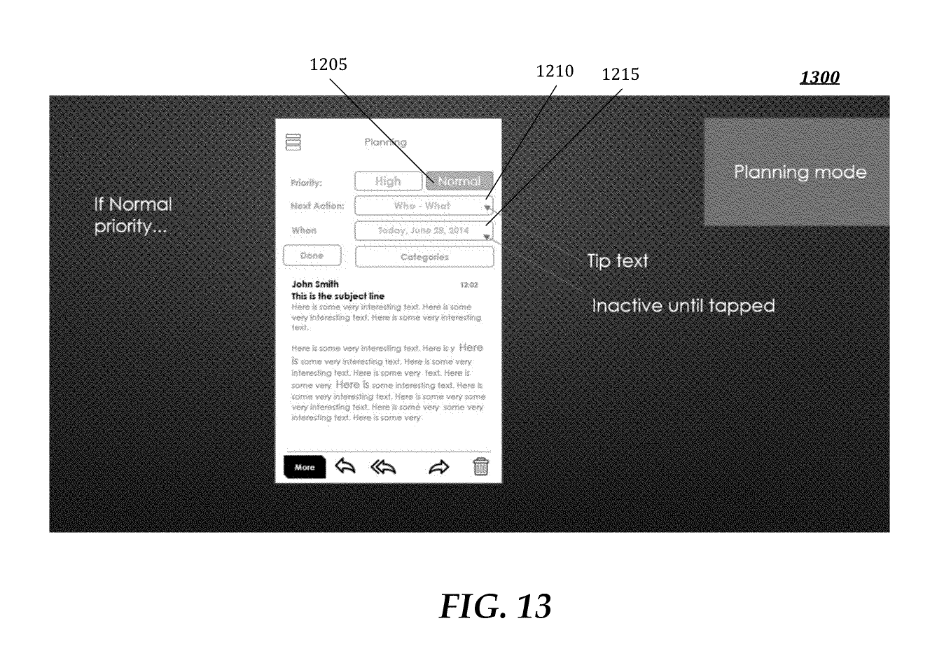

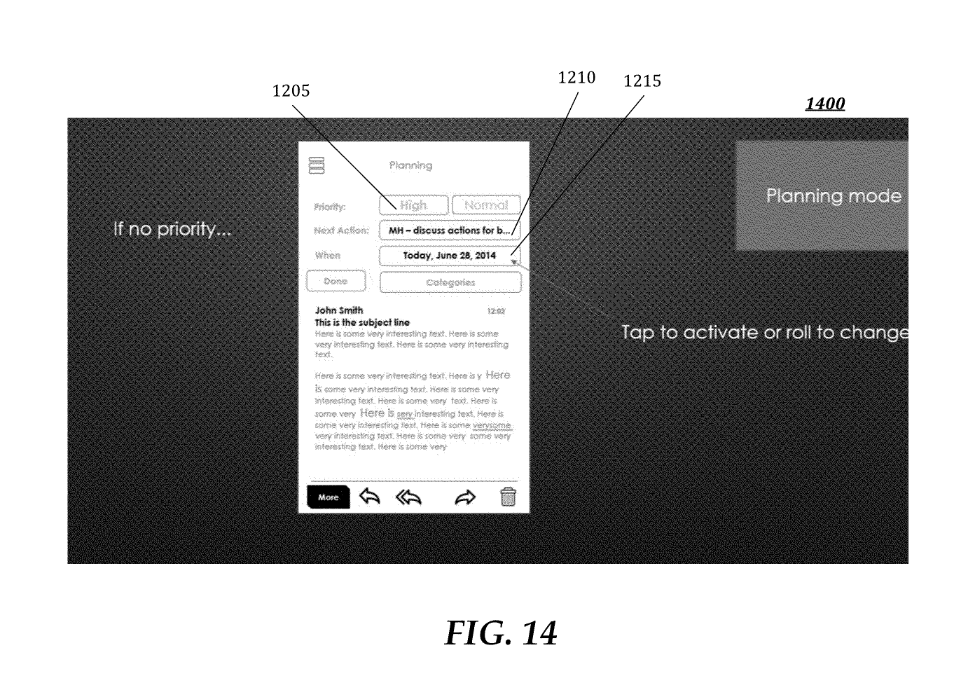

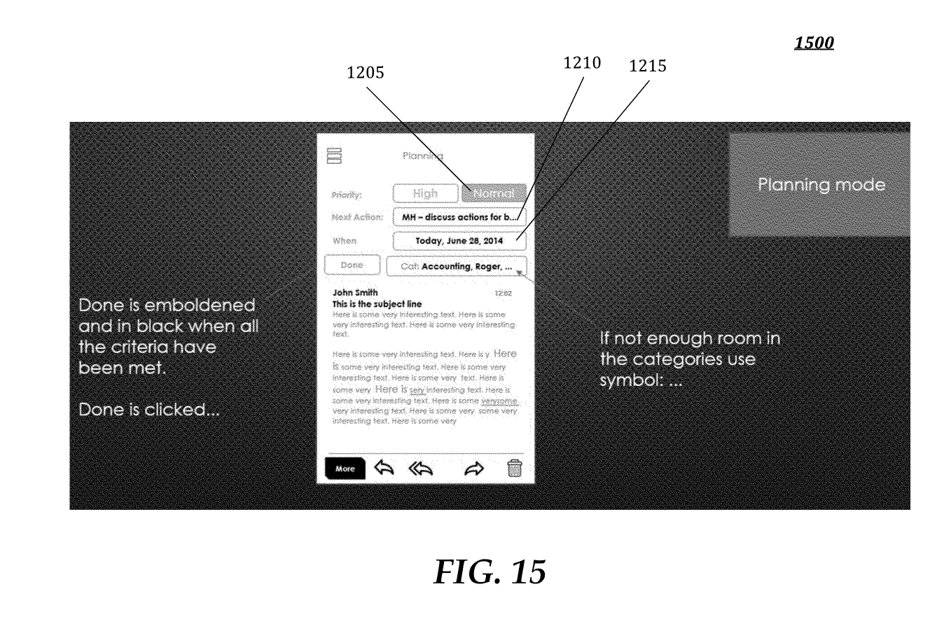

FIG. 12-16 shows a screenshot of an embodiment of the plan view having an interface suitable for a touch-screen on, for example, a mobile computing device or tablet. FIG. 12 is a screenshot 1200 consistent with embodiments of the present disclosure showing a mobile device implementation of the planning stage with the priority 1205, next action 1210 and due date for completion 1215. FIG. 13 is a screenshot 1300 consistent with embodiments of the present disclosure showing a mobile device implementation of the planning stage with only the priority selected. FIG. 14 is a screenshot 1400 showing the implementation of the planning stage without the priority discussed. FIG. 15 is a screenshot 1500 showing the mobile device implementation of the planning stage with a normal priority, next action, designated user to perform the next action, and due date.

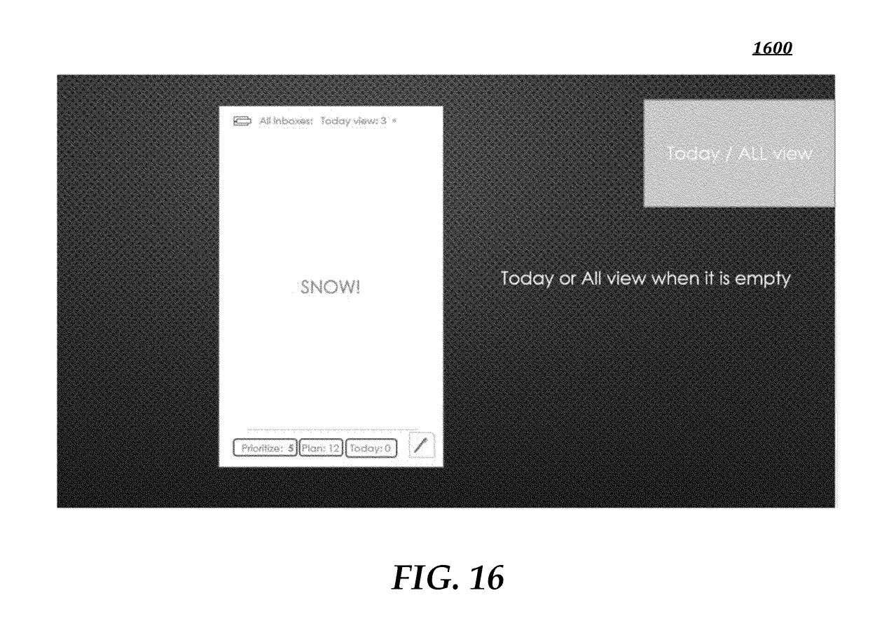

In some embodiments, once the email objects have all been processed, the prioritize screen may display “SNOW” or another word with a white background, indicating that it no more tasks require prioritizing and planning. “SNOW” may be substituted with any other picture whether hyperlinked to a website, showing a dashboard or other media within the browser area. FIG. 16 is a screenshot 1600 consistent with embodiments of the present disclosure showing a mobile device implementation of the Today view.

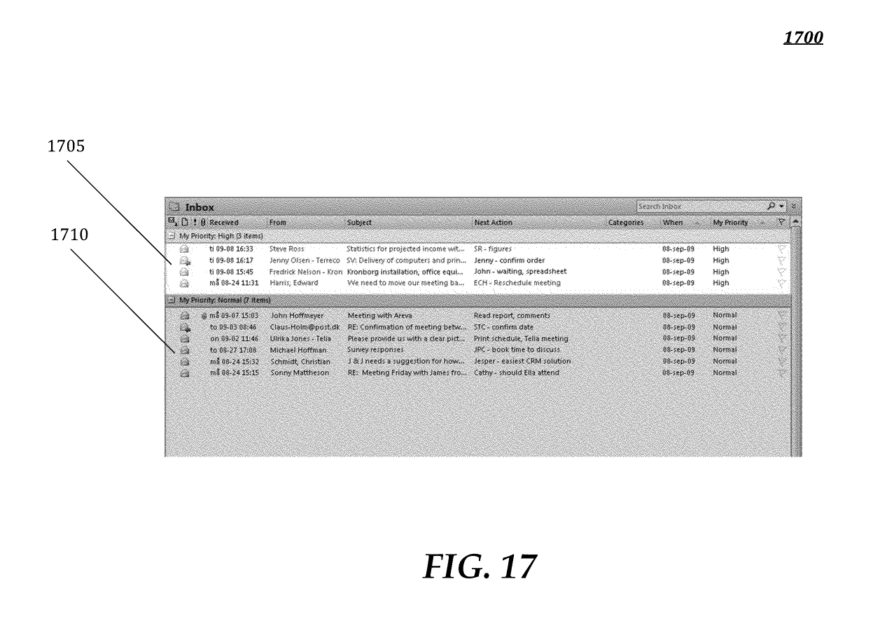

From stage 230, where the messages are further processed, method 200 may proceed to stage 240, where computing device 3900 may enable the user to view his email objects as task objects. FIG. 17 shows a screenshot of the Today view 1700 as an add-in in Microsoft Outlook®. The Today view enables the user to see what needs to get done for the current day. The Today view may be sorted by priority and then by Next Action by default, for example, by displaying high-priority items 1705 in the top grouping and lower priority items 1710 in the bottom grouping, while sorting the Next Actions alpha-numerically within those groups. In this way, the user may be enabled to plan his day and avoid re-reading and re-analyzing emails in the user's inbox while attending first to the most important matters; and at the same time like items are sorted together in the Next Action column.

In some embodiments, a third grouping may be provided of non-mail objects such as, for example, but not limited to, notes (e.g. post-it notes). Objects within the third grouping may appear, for example, below the highest priority and be subsequently regrouped with other prioritization categories by the user.

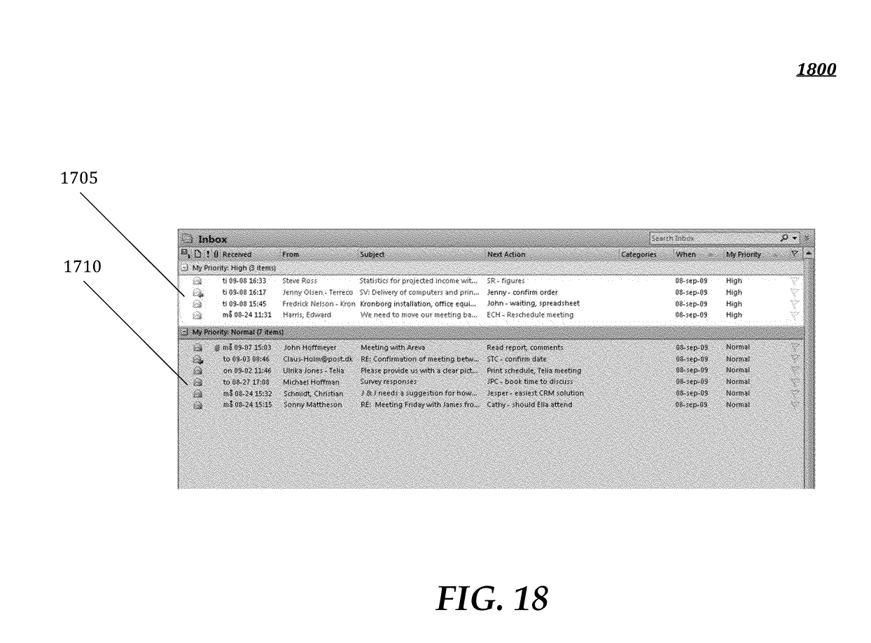

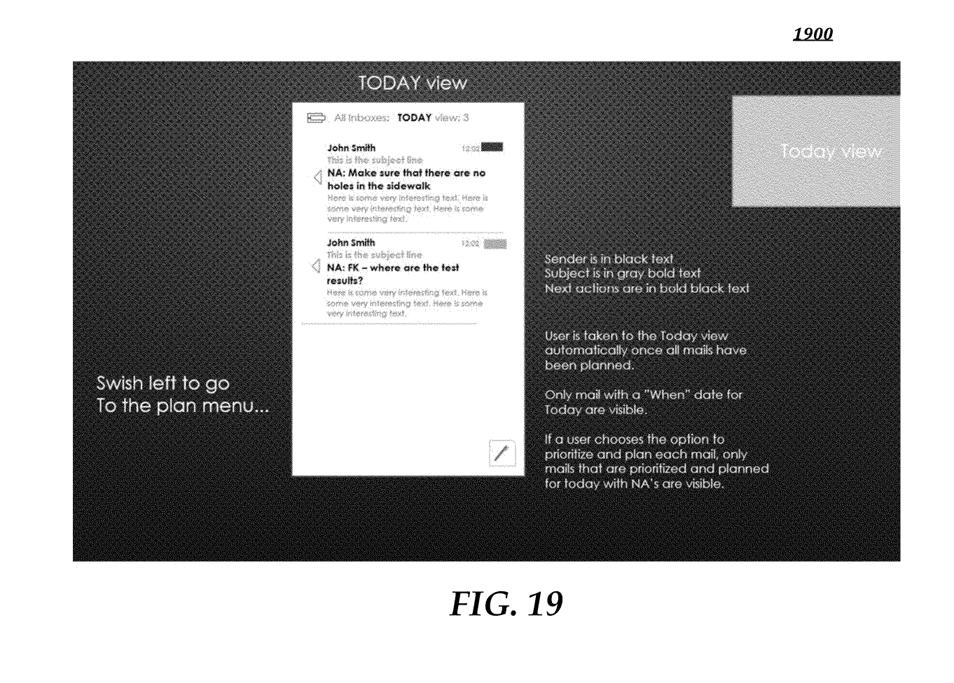

FIG. 18 is a screenshot 1800 consistent with embodiments of the present disclosure showing the implementation of the Today view. FIG. 19 illustrates a screenshot 1900 of the Today view on a mobile app consistent with embodiments of the present disclosure.

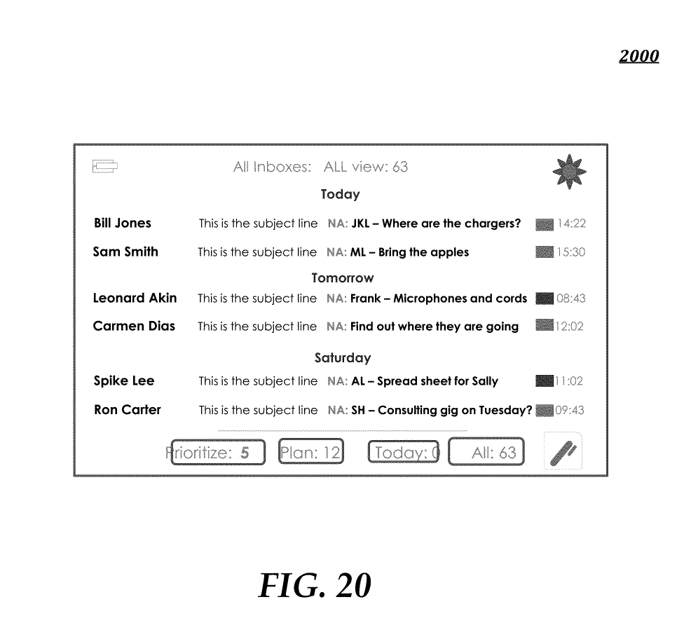

The platform may further enable the user to view all of his email/tasks in the “All” view. Embodiments of this present disclosure may allow the user to sort his tasks by due date then by Next action. Further, embodiments of the platform may allow the user to sort by priority. In some embodiments, the All view may be presented in a vertical manner. Embodiments of the platform may further enable the user to rotate the screen to make a horizontal, wide-screen view by rotating the screen and using internal sensors in the computing device. FIG. 20 shows a screenshot 2000 consistent with embodiments of the present disclosure showing the implementation of the horizontal All view.

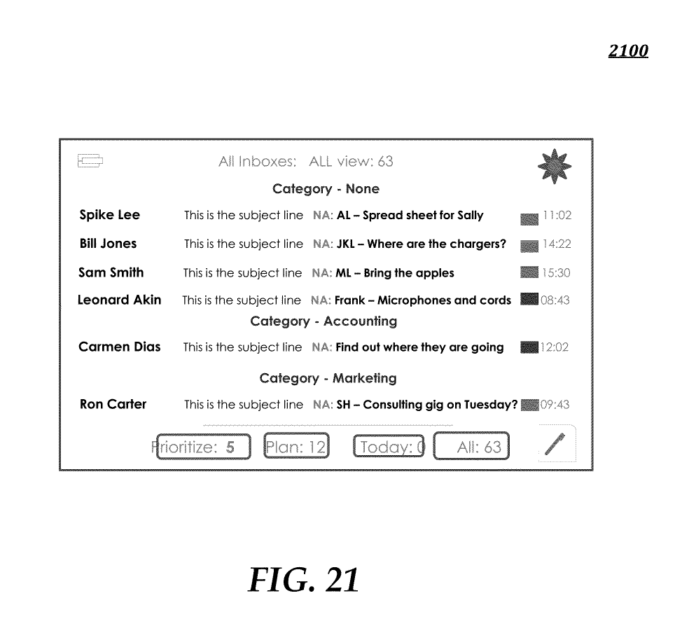

In various embodiments, the sorting may be nested, such that, for example, the tasks are sorted by due date and then within each due date, the tasks may be sorted by priority. FIG. 21 shows a screenshot 2100 consistent with embodiments of present disclosure for tasks sorted by category, then date. Once the tasks have all been completed for the given period, the Today screen may display “SNOW” with a white background, indicating that it no more tasks require action, as shown in FIG. 16.

The embodiments of the present disclosure may be configured to conform to the user's preferences. For example, an option may be selected to prevent the user from ignoring emails, for example, by requiring the user to select a priority. Another user-configurable preference provided by the platform may, upon activation, prevent the user from ignoring the “next action” field when processing his emails. Further, another user-configurable preference may prevent the user from ignoring the “due date” field. Another configuration may include the options for the archive fields, where the platform allows the user to select how he would like his archive fields to be configured. Also, the platform may be configured so that the prioritization stage and the plan stage are provided in a single stage, rather than two separate stages.

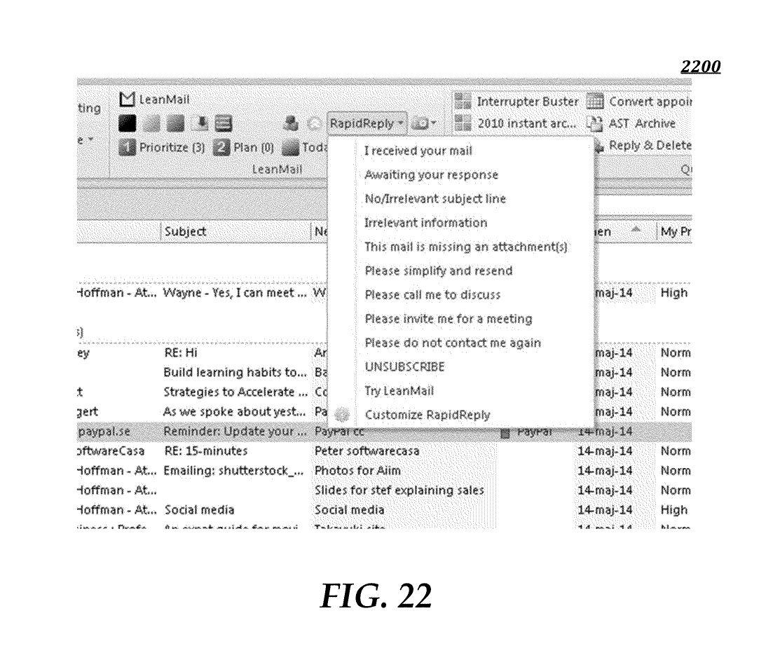

Embodiments of this present disclosure may enable the user to further manipulate email communication. For example, embodiments may contain the “RapidReply” function that replies to messages in two clicks, first by clicking the RapidReply button and then selecting the pre-recorded message from a dropdown menu. Further, the user may customize (add and edit) RapidReply messages. FIG. 22 shows a screenshot 2200 of how RapidReply may be implemented as a Microsoft Outlook® add-in.

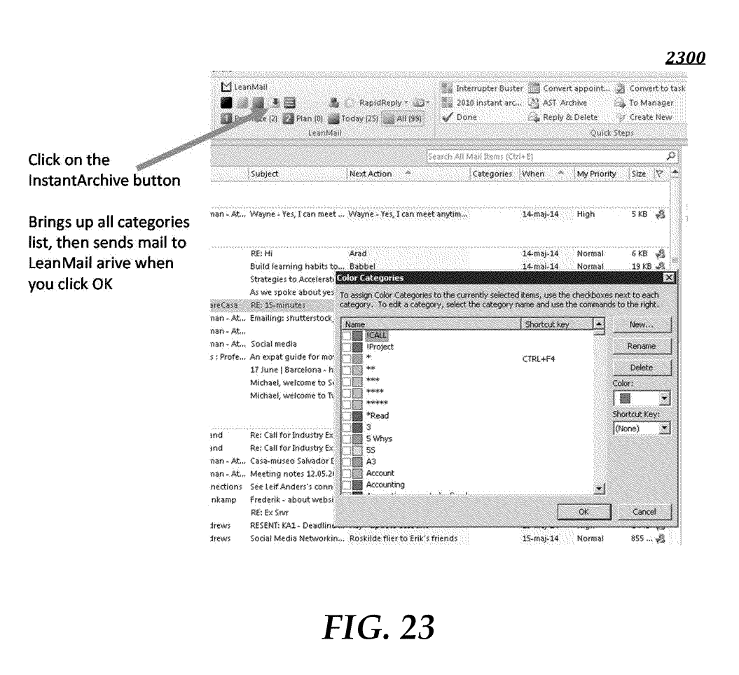

As another example of a function for manipulating messages, embodiments of this present disclosure may employ an InstantArchive button that allows the user to pull up a list of categories and send a message directly to a folder where it stores the now-categorized mails once OK is selected. FIG. 23 shows a screenshot 2300 of how InstantArchive may be implemented as a Microsoft Outlook® add-in. Further, mails older than a certain age, i.e. one month, can be automatically moved to another folder in order to distinguish between current and older mails. Additionally, embodiments of the present disclosure may allow the user to send mail within a selected category and ask if the user would like to delete the original mail.

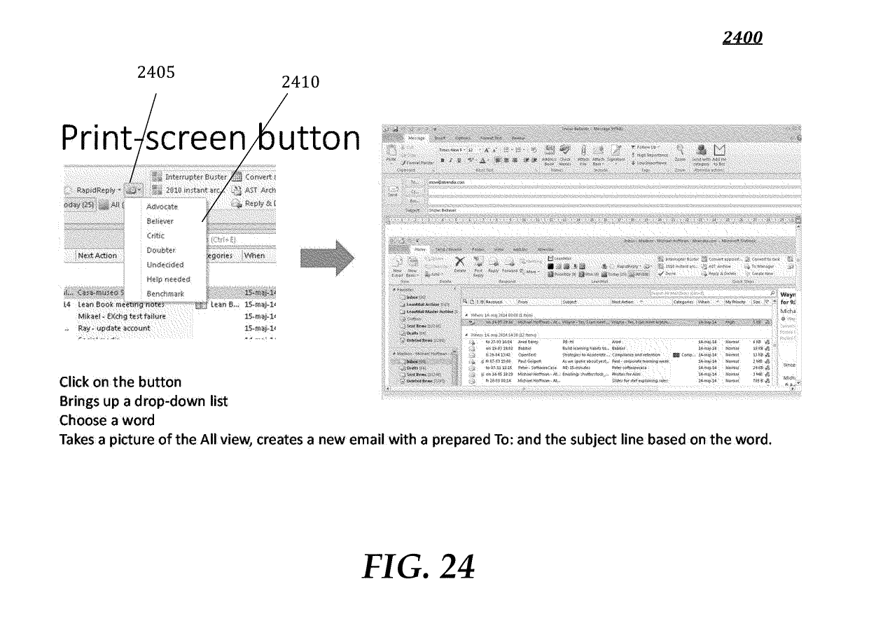

Another function that may be implemented into embodiments of the present disclosure may comprise a Print-screen button. The button may enable the user to, by selecting a subject from a drop-down menu, take a picture of the All view and create a new message with the desired subject. FIG. 24 shows a screenshot 2400 of how Print-screen may be implemented as a Microsoft Outlook® add-in. Further, embodiments of the present disclosure may allow the user to, by selecting a button 2405, add himself to the Bcc for future messages. In addition, embodiments of the present disclosure may allow the user to send mail with a selected category 2410.

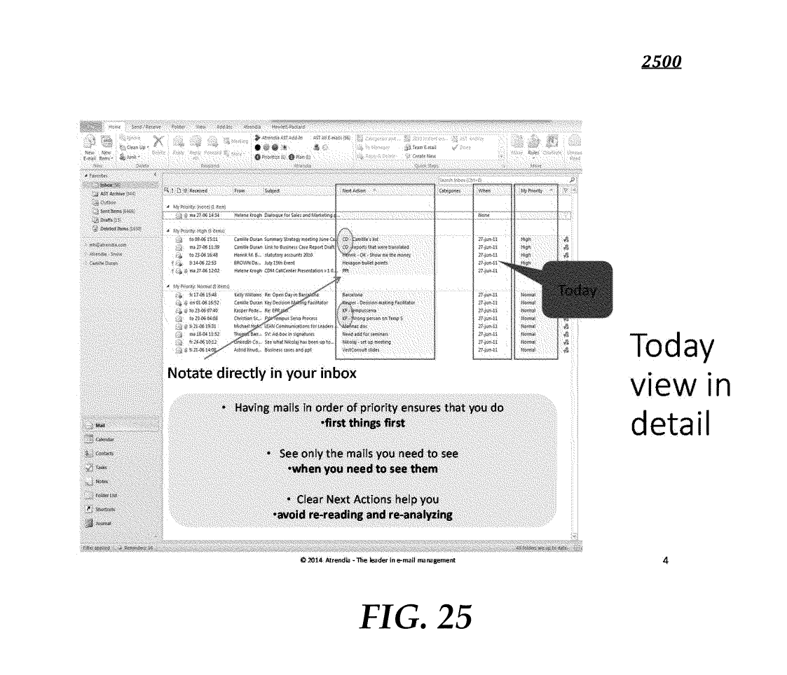

The platform may further enable team-based email and task management. In various embodiments, different users of the platform may be granted different privileges and permissions in the platform. For instance, an admin user may be able to view the email objects of a different user and perform the method 200 in prioritizing and planning the email objects into tasks objects. In various other embodiments, an admin user may be able to assign their own email objects as tasks for another user through a shared inbox functionality. FIGS. 25-38 disclose example embodiments, features, and functions associated with a shared inbox functionality. Accordingly, an admin user may assign and view an entire team's tasks list as a function of their email objects.

Still consistent with embodiments of the present disclosure, a Customer rating may be appended to a mail when, upon receiving the mail from a particular domain, a database is queried and the appropriate Customer rating is affixed to the mail in the Customer rating column. The Customer rating may be based on, for example, but not limited, a domain authority of the particular domain. Further still, the Customer rating may also be added manually as an input field, much like other input field presented in an inbox view of the present disclosure.

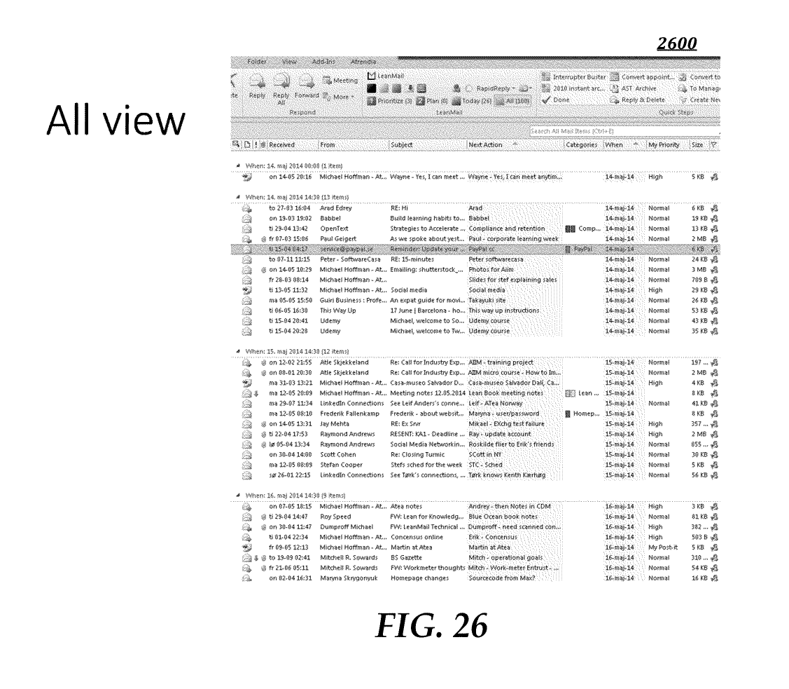

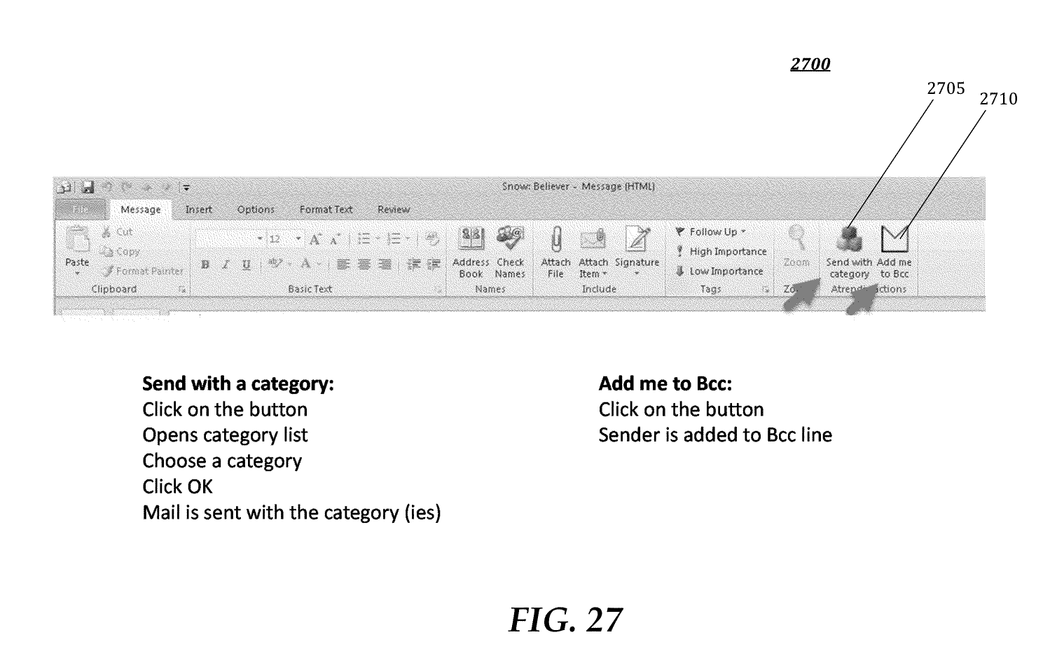

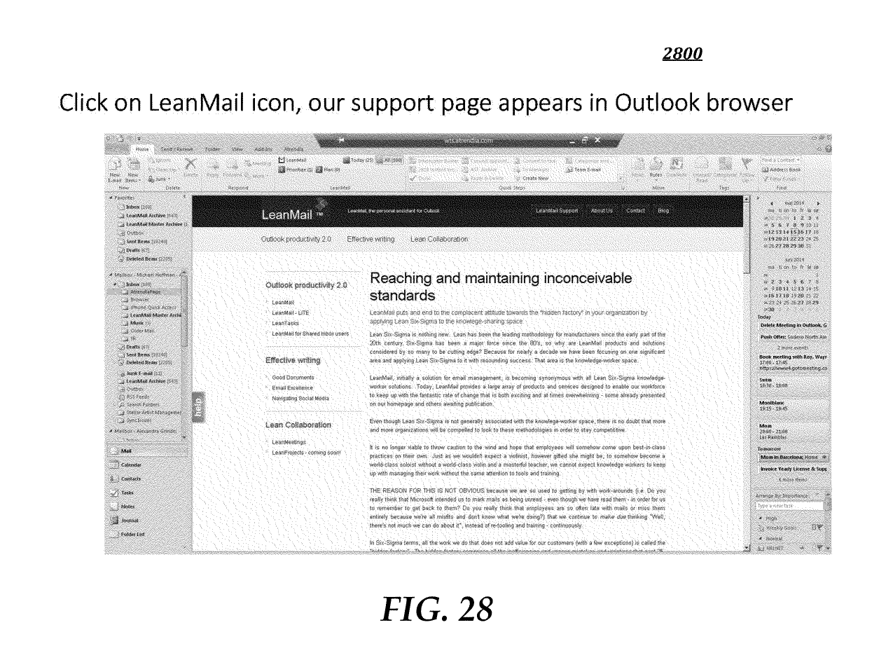

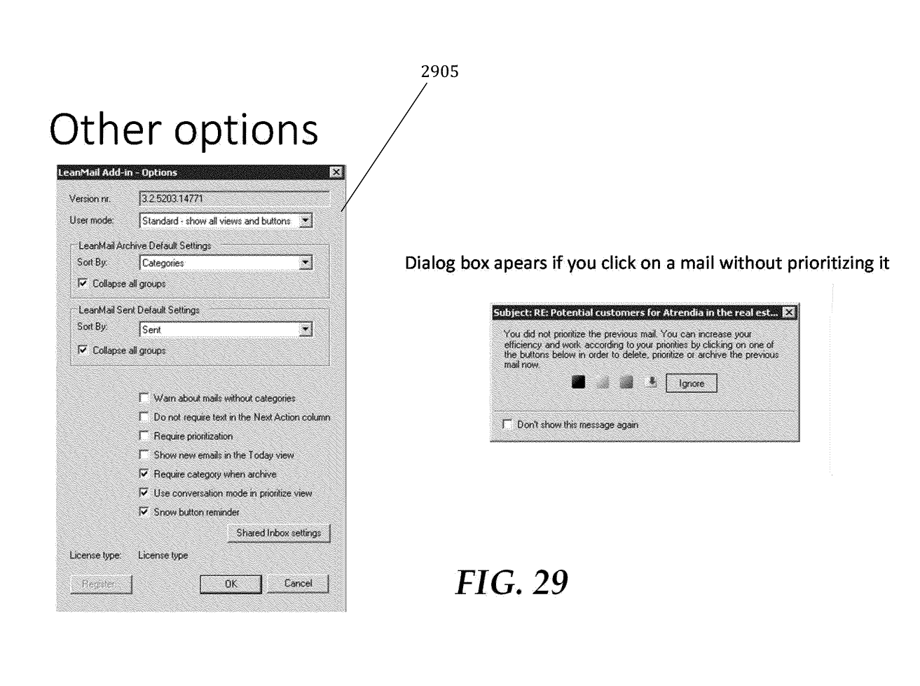

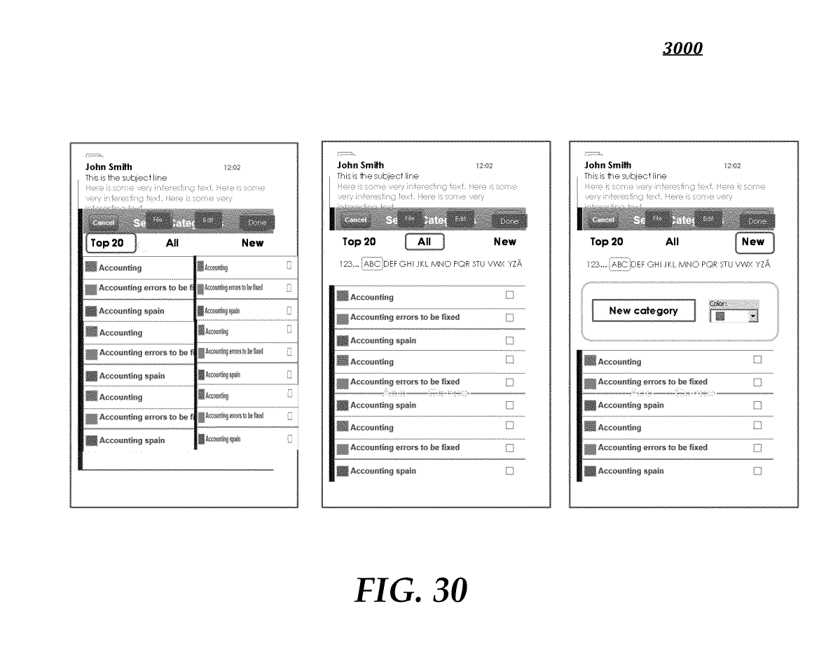

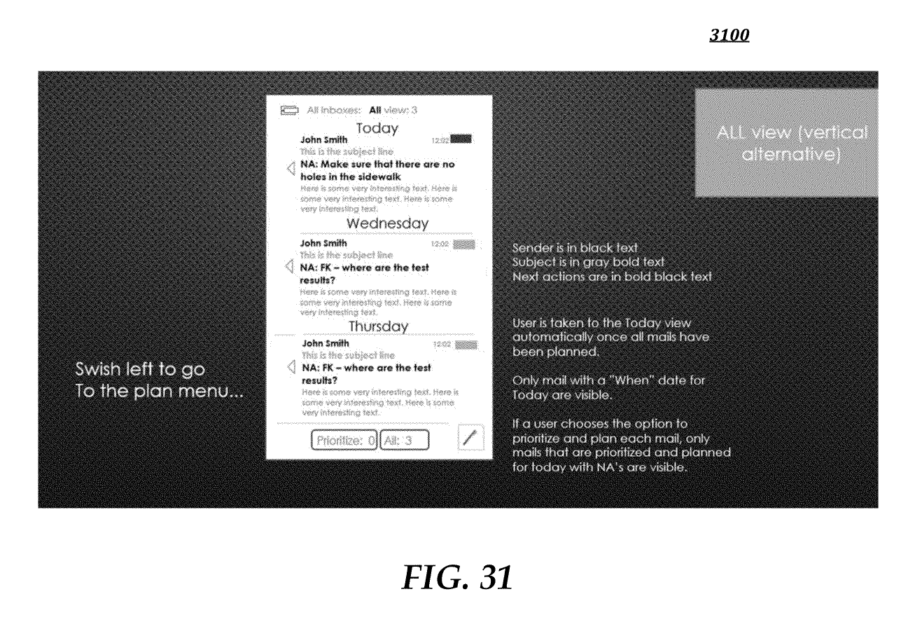

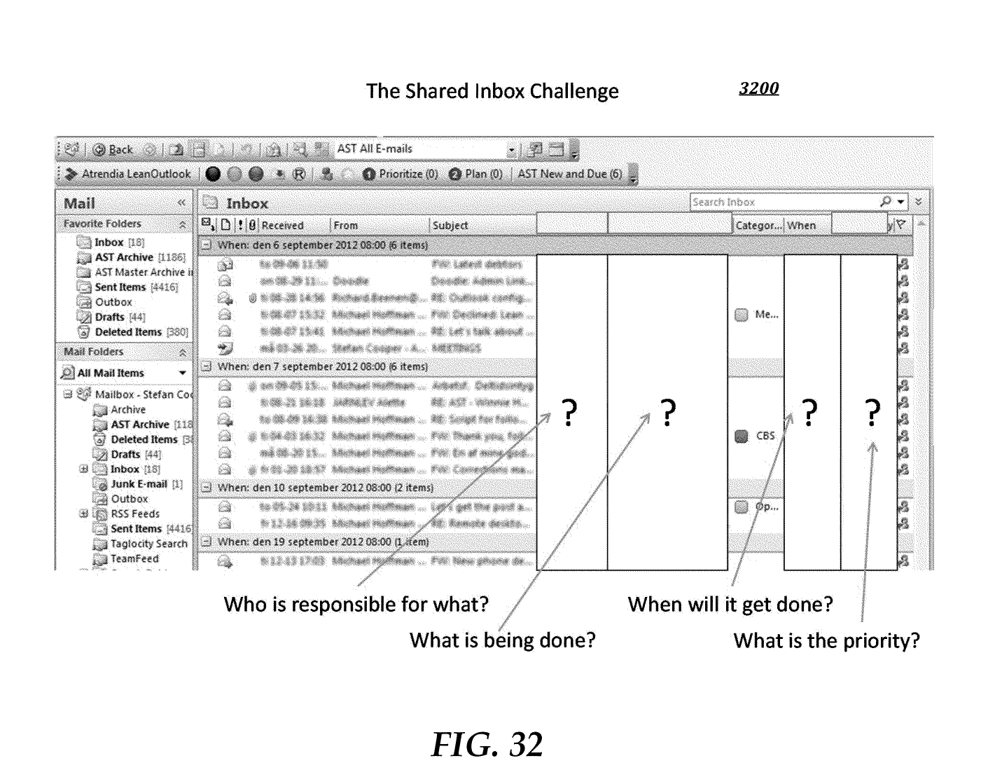

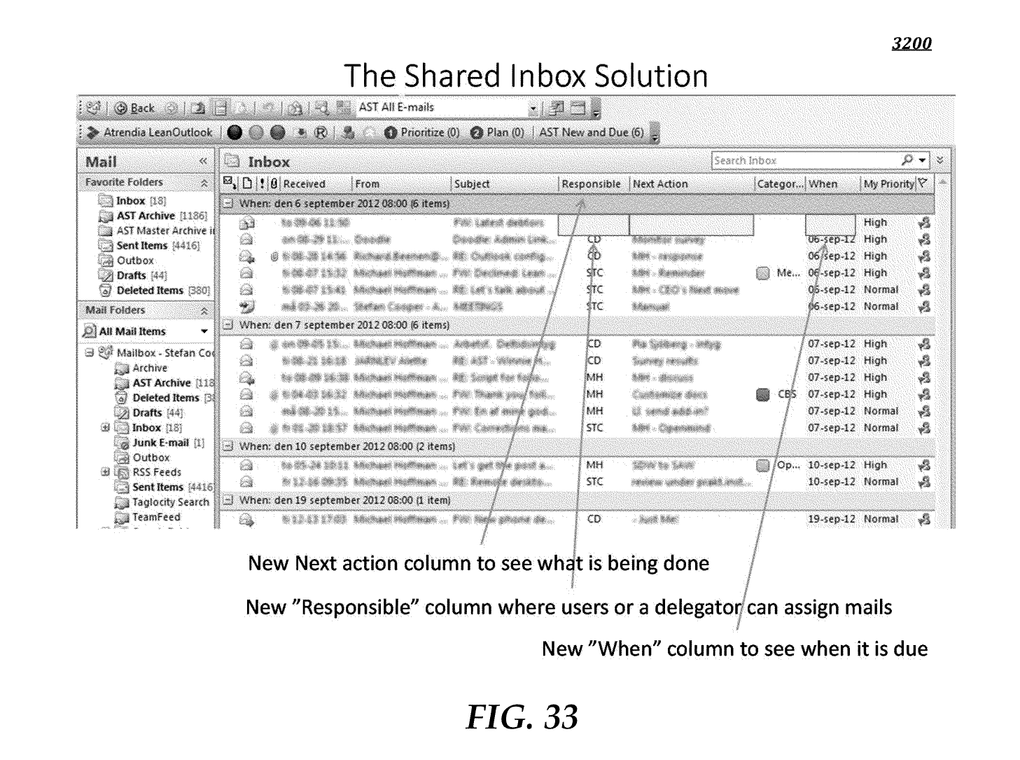

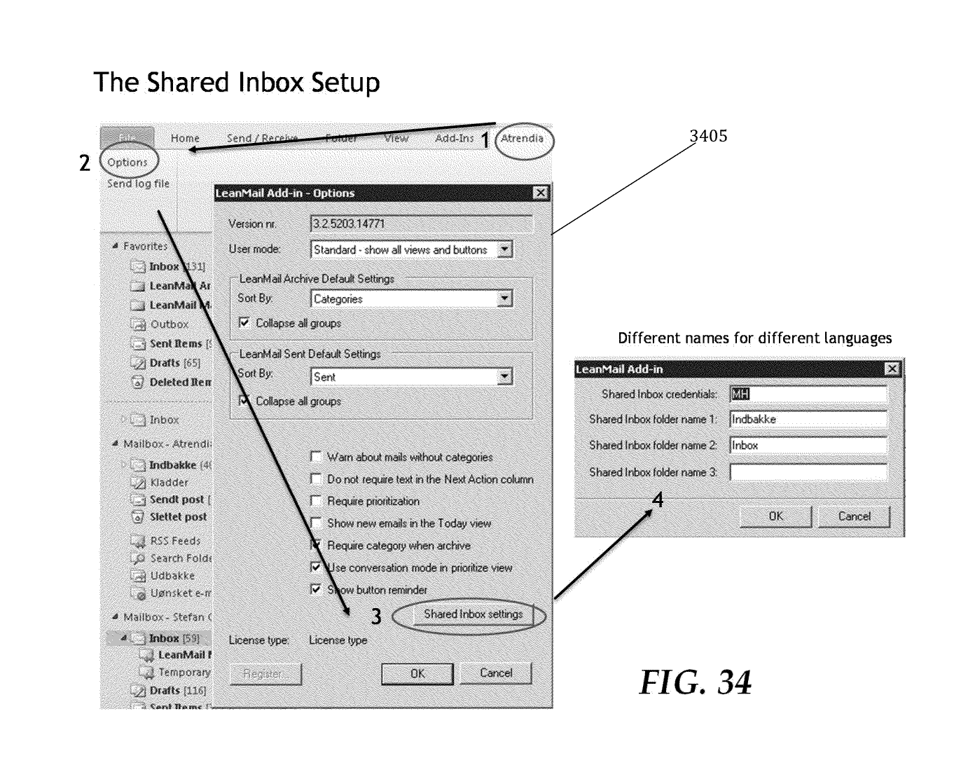

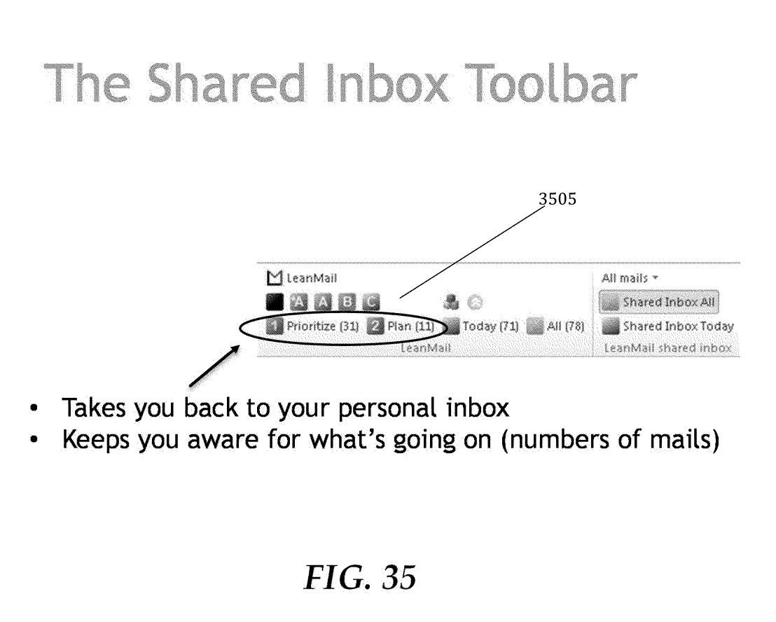

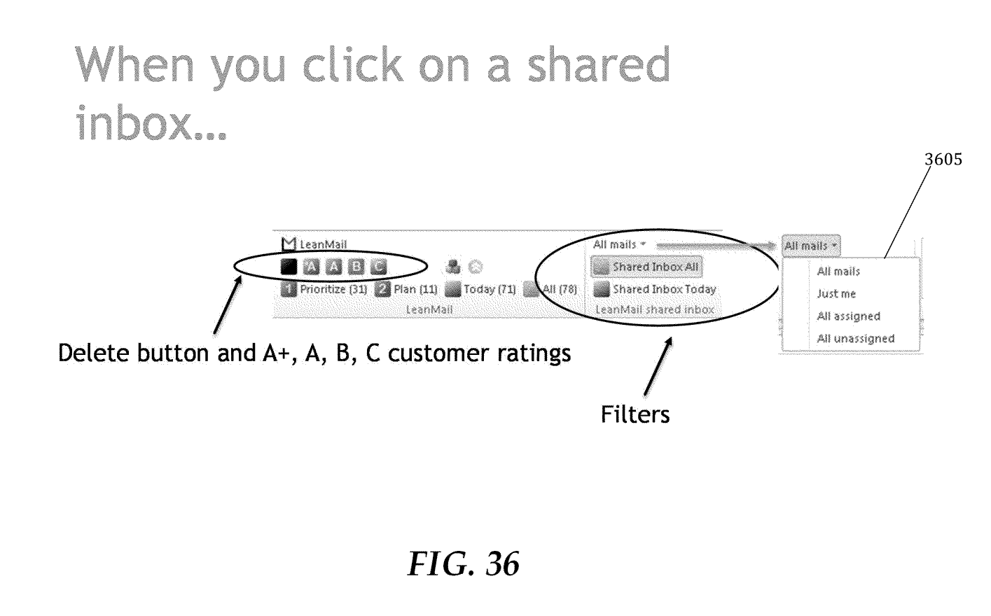

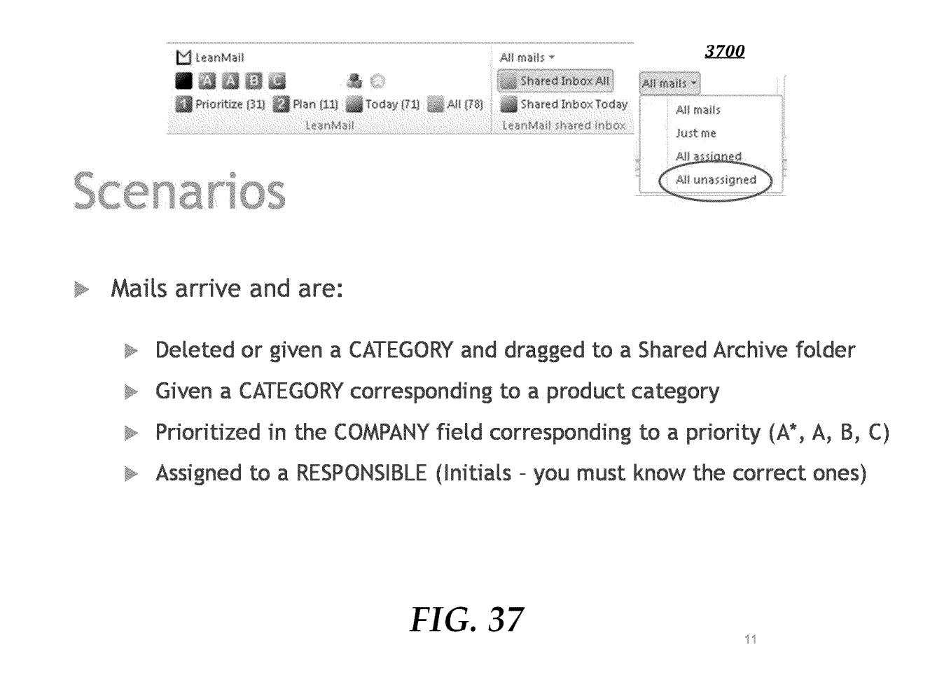

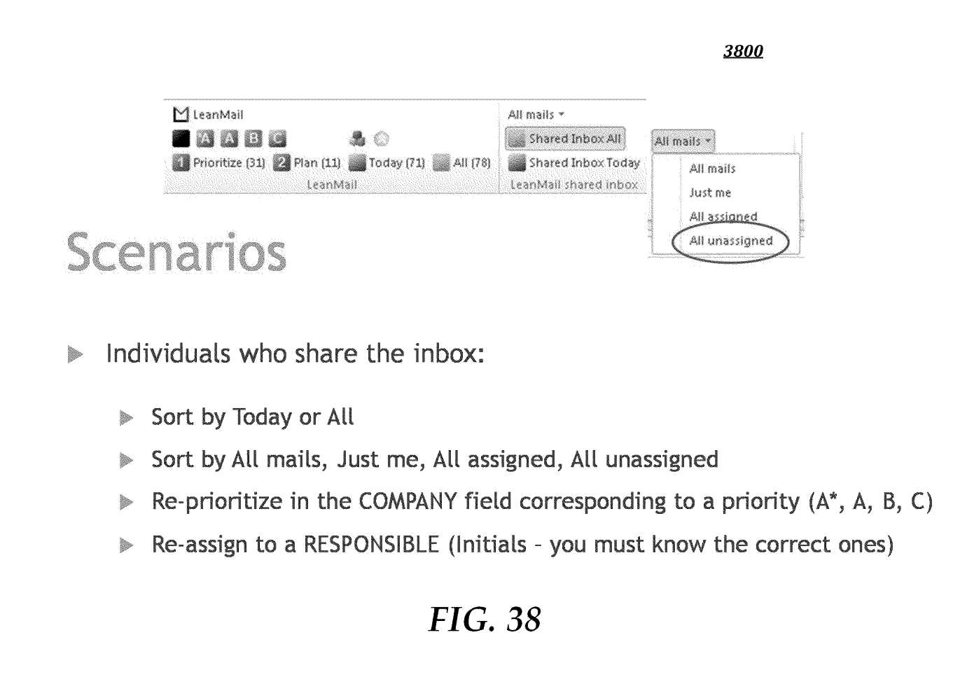

FIG. 25 illustrates a screenshot 2500 of a Today view as a Microsoft Outlook® plug-in. FIG. 26 illustrates a screenshot 2600 of an All view as a Microsoft Office plug-in. FIG. 27 illustrates a screenshot 2700 showing button 2705 and button 2710 for using features “Send with Category” and “Add me to BCC”, respectively. FIG. 28 illustrates a screenshot 2800 for a support page within the Microsoft Outlook® program. FIG. 29 illustrates an “other options” menu 2905 consistent with embodiments of the present disclosure. FIG. 30 illustrates screenshots 3000 for creating a new category of task and/or email. FIG. 31 illustrates a screenshot 3100 and instructions for enabling the user to go to the plan menu. FIG. 32 illustrates a screenshot 3200 for a Shared Inbox Challenge. FIG. 33 illustrates a screenshot 3300 for a Shared Inbox Solution. FIG. 34 illustrates a shared inbox set-up menu 3405 consistent with embodiments of the present disclosure. FIG. 35 illustrates a shared inbox toolbar 3505. FIG. 36 illustrates sorting options 3505 for a shared inbox. FIG. 37 illustrates scenarios 3700 for the shared inbox. FIG. 38 illustrates further scenarios 3800 for the shared inbox.

IV. Platform Architecture

The email and task management platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. Although method 200 has been described to be performed by a computing device 3900, it should be understood that, in some embodiments, different operations may be performed by different networked elements in operative communication with computing device 3900.

Embodiments of the present disclosure may comprise a system having a memory storage and a processing unit. The processing unit may be coupled to the memory storage, wherein the processing unit is configured to perform the stages of method 200.

FIG. 39 is a block diagram of a system including computing device 3900. Consistent with an embodiment of the disclosure, the aforementioned memory storage and processing unit may be implemented in a computing device, such as computing device 3900 of FIG. 39. Any suitable combination of hardware, software, or firmware may be used to implement the memory storage and processing unit. For example, the memory storage and processing unit may be implemented with computing device 3900 or any of other computing devices 3918, in combination with computing device 3900. The aforementioned system, device, and processors are examples and other systems, devices, and processors may comprise the aforementioned memory storage and processing unit, consistent with embodiments of the disclosure.

With reference to FIG. 39, a system consistent with an embodiment of the disclosure may include a computing device, such as computing device 3900. In a basic configuration, computing device 3900 may include at least one processing unit 3902 and a system memory 3904. Depending on the configuration and type of computing device, system memory 3904 may comprise, but is not limited to, volatile (e.g. random access memory (RAM)), non-volatile (e.g. read-only memory (ROM)), flash memory, or any combination. System memory 3904 may include operating system 3905, one or more programming modules 3906, and may include a program data 3907. Operating system 3905, for example, may be suitable for controlling computing device 3900's operation. In one embodiment, programming modules 3906 may include for example, message sorting, data embedding, and message displaying. Furthermore, embodiments of the disclosure may be practiced in conjunction with a graphics library, other operating systems, or any other application program and is not limited to any particular application or system. This basic configuration is illustrated in FIG. 39 by those components within a dashed line 3908.

Computing device 3900 may have additional features or functionality. For example, computing device 3900 may also include additional data storage devices (removable and/or non-removable) such as, for example, magnetic disks, optical disks, or tape. Such additional storage is illustrated in FIG. 39 by a removable storage 3909 and a non-removable storage 3910. Computer storage media may include volatile and nonvolatile, removable and non-removable media implemented in any method or technology for storage of information, such as computer readable instructions, data structures, program modules, or other data. System memory 3904, removable storage 3909, and non-removable storage 3910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 3900. Any such computer storage media may be part of device 3900. Computing device 3900 may also have input device(s) 3912 such as a keyboard, a mouse, a pen, a sound input device, a touch input device, etc. Output device(s) 3914 such as a display, speakers, a printer, etc. may also be included. The aforementioned devices are examples and others may be used.

Computing device 3900 may also contain a communication connection 3916 that may allow device 3900 to communicate with other computing devices 3918, such as over a network in a distributed computing environment, for example, an intranet or the Internet. Communication connection 3916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 3904, including operating system 3905. While executing on processing unit 3902, programming modules 3906 (e.g., message sorting application 3920) may perform processes including, for example, one or more of method 200's stages as described above. The aforementioned process is an example, and processing unit 3902 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart.

1. A method comprising:
receiving an email to be associated with a task item;
displaying the email to a user in a touch-screen-compatible format;
receiving an indication of a swipe motion at the email's displayed location;
prioritizing the email based on the swipe motion;
creating a prioritized task associated with the email and the corresponding priority; and
displaying a prioritized tasks list comprised of prioritized emails.

2. The method of claim 1, further comprising receiving task details associated with the prioritized task comprising at least one of the following:
a next action,
a designated user to perform the next action, and
a due date.

3. The method of claim 2, wherein receiving the task details comprises receiving the next action as a direct input field in a listing of email items associated with prioritized tasks.

4. The method of claim 1, further comprising enabling the user to sort the displayed list of prioritized tasks.

5. The method of claim 2, further comprising sorting the displayed list of prioritized tasks by at least one of the following: the priority and at least one of the task details.

6. The method of claim 1, further comprising enabling the user to filter the displayed list of prioritized tasks.

7. The method of claim 2, further comprising filtering the displayed list of prioritized tasks by at least one of the following: the priority and at least one of the task details.

8. The method of claim 1, further comprising deleting the email upon based on a direction of the swipe motion.

9. The method of claim 1, further comprising archiving the email upon based on a direction of the swipe motion.

10. The method of claim 9, further comprising enabling the user to select a folder in which to archive the email.

11. The method of claim 1, further comprising synchronizing actions received on the touch enabled device with a client-side mail application.

12. The method of claim 2, wherein receiving task details associated with a prioritized task comprises receiving a task detail from a pre-made list.

13. The method of claim 1, further comprising displaying to the user options for the priority based on a first portion of the swipe motion.

14. The method of claim 1, further comprising disabling at least the following: at least one of the priorities and an option to ignore the email, wherein disabling comprises disabling upon a condition, wherein the condition comprises at least one of the following:
a due date, and
a priority.

15. (canceled)

16. A computer readable medium comprising a set of instructions which when executed perform a method comprising:
receiving an email object;
displaying the email to a user in a list view;
receiving an indication of priority for the email;
receiving planning details associated with the email;
creating a prioritized and planned task associated with the email based on the indication of priority and the planning details; and
displaying a prioritized tasks list comprised of prioritized and planned emails.

17. The computer readable medium of claim 16, wherein receiving the planning details comprises receiving an indication of at least one of the following:
a next action,
a designated user to perform the next action, and
a due date.

18. The computer readable medium of claim 17, wherein receiving the indication of priority and the planning details comprises receiving user inputs prior to displaying a contents of the email.

19. A system comprising:
a memory storage; and
a processing unit coupled with the memory storage, wherein the processing unit is operative to:
display a plurality of email objects;
receive an indication of a swipe motion at an email's displayed location;
categorize a priority of an email associated with the swipe motion's location, the priority being based on a direction of the swipe motion;
create a prioritized task associated with the email and the corresponding categorized priority;
display a prioritized task list comprised of categorized emails; and
receiving a selection of the prioritized tasks; and
displaying, in response to the selection, the contents of the email associated with the prioritized task.

20. The system of claim 18, wherein the processing unit is further operative to receive task details associated with the prioritized task comprising at least one of the following:
a next action,
a designated user to perform the next action, and
a due date.
